(19) United States
(12) Patent Application Publication
(10) Pub. No.: US 2017/0005432 A1
(43) Pub. Date: Jan. 5, 2017

(54) PERIPHERAL WEDGE SEAL MEMBER

(71) Applicant: TYCO ELECTRONICS CORPORATION, Berwyn, PA (US)

(72) Inventor: William Henry BERNHART, Elizabethtown, PA (US)

(21) Appl. No.: 14/788,938

(22) Filed: Jul. 1, 2015

(51) Int. Cl. H01R 13/52; H01R 13/533

(52) U.S. Cl. CPC H01R 13/5219; H01R 13/533

(57) ABSTRACT

A peripheral wedge seal member for use with a plug connector housing and a receptacle connector housing. The peripheral wedge seal member includes a deformable body which has tapered walls which extend from a thicker first end to a less thick second end. Each of the walls has a first surface and a second surface which is angled with respect to the first surfaces. Each of the walls has a compliant section which absorbs forces transmitted by the plug connector housing, the receptacle connector housing or both. Each compliant section has at least one groove extending along the first surface and at least one support rib provided proximate the at least one groove.

### FIELD OF THE INVENTION

The present invention is directed to a peripheral wedge seal member. In particular, the invention is directed to a peripheral wedge seal member which provides sealing and vibration dampening between a housing of a plug connector and a housing of a receptacle connector.

### BACKGROUND OF THE INVENTION

An electrical connector assembly includes a first or plug connector and a second or receptacle connector that are configured to mate with one another. Each connector typically has a housing and at least one cavity extends through the housing. Each cavity is configured to receive a terminal fitting. One end of each terminal fitting typically is connected to a conductor, such as the wire, cable, busbar, an electrical device or a conductive region of a circuit board. The opposed end of each terminal fitting is configured for achieving electrical connection with a terminal fitting in the mating connector.

Many connectors, such as those used in automotive vehicles, will be exposed to harsh environments in which moisture and vibrations can cause the electrical connection between the mating connectors to fail. For example, while the housing of an electrical connector is typically formed from a resin or other material that can withstand periodic exposure to moisture, if the assembly is not properly sealed, moisture can adversely affect the metallic terminal fittings and can cause a shorting between two terminal fittings. A short circuit can have serious effects on critical components of a vehicle, such as warning lights, airbags and the like.

Many connectors include an elastomeric seal to prevent intrusion of moisture into the region of the connector that contains the terminal fittings and the conductors to which the terminal fittings are connected. A seal of this type typically is mounted at an area where two parts of the mating housings will telescope together. For example, a frame-shaped seal or a toroid-shaped seal may be mounted over one housing of a connector assembly. The end of the mating housing will abut against the seal when the housings are connected. Thus, the seal engages the interface between the two housings to provide sealing.

However, many of the known seals do not have sufficient structural flexibility to provide proper sealing and vibration dampening for a wide range of dimensions or in a wide range of environments. In addition, mating and un-mating forces associated with known seals makes it difficult to access when service is required.

It would, therefore, be beneficial to have a peripheral wedge seal which can be used to effectively seal the assembly over a wide range of functional dimensions, provides for lower mating and un-mating forces, provides more compliancy, and provides sufficient vibration dampening between the plug connector and the receptacle connector even in harsh environments.

### SUMMARY OF THE INVENTION

An embodiment is directed to a seal member for use with a plug connector housing and a receptacle connector housing. The seal member includes a deformable body which has tapered walls which extend from a thicker first end to a less thick second end. Each of the walls has a first surface and a second surface which is angled with respect to the first surface. At least one groove extends along the first surface. At least one support rib is provided proximate the at least one groove. The at least one groove and the at least one support rib form a spring member which allows the deformable body of the seal member to compress when the plug connector housing and the receptacle connector housing are mated together.

An embodiment is directed to a peripheral wedge seal member for use with a plug connector housing and a receptacle connector housing. The peripheral wedge seal member includes a deformable body which has tapered walls which extend from a thicker first end to a less thick second end. Each of the walls has a first surface and a second surface which is angled with respect to the first surfaces. Each of the walls has a compliant section which absorbs forces transmitted by the plug connector housing, the receptacle connector housing or both. Each compliant section has at least one groove extending along the first surface and at least one support rib provided proximate the at least one groove.

An embodiment is directed to a peripheral wedge seal member for use with a plug connector housing and a receptacle connector housing. The peripheral wedge seal member includes a deformable body which has tapered walls which extend from a thicker first end to a less thick second end. The walls have first surfaces and second surfaces which are angled with respect to the first surfaces. Each of the walls has a compliant section which absorbs forces transmitted by the plug connector housing, the receptacle connector housing or both. Each compliant section has at least one groove extending along the first surface, at least one support rib provided proximate the at least one groove, at least one recess which extends along the second surface and at least one deformable rib which is provided proximate the at least one recess.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a cross-sectional view of a plug connector and a receptacle connector prior to being mated together, the plug connector having an illustrative embodiment of the peripheral wedge seal member of the present invention.

FIG. 2 is a cross-section view of the plug connector and the receptacle connector of FIG. 1 shown in a partially mated position.

FIG. 3 is a cross-section view of the plug connector and the receptacle connector of FIGS. 1 and 2 shown in a fully mated position.

FIG. 4 is a top perspective view of the illustrative peripheral wedge seal member shown in FIG. 1.

FIG. 5 is a bottom perspective view of the illustrative peripheral wedge seal member shown in FIG. 4.

FIG. 6 is a cross-sectional view of the illustrative peripheral wedge seal member shown in FIG. 4.

FIG. 7 is a top perspective view of an alternate illustrative peripheral wedge seal member.

FIG. 8 is a bottom perspective view of the illustrative peripheral wedge seal member shown in FIG. 7.

FIG. 9 is a cross-sectional view of the illustrative peripheral wedge seal member shown in FIG. 7.

### DETAILED DESCRIPTION OF THE INVENTION

The present invention will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that spatially relative terms, such as “top”, “upper”, “lower” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “over” other elements or features would then be oriented “under” the other elements or features. Thus, the exemplary term “over” can encompass both an orientation of over and under. The device may be otherwise oriented (rotated 90 degrees or at other orientations) and the spatially relative descriptors used herein interpreted accordingly.

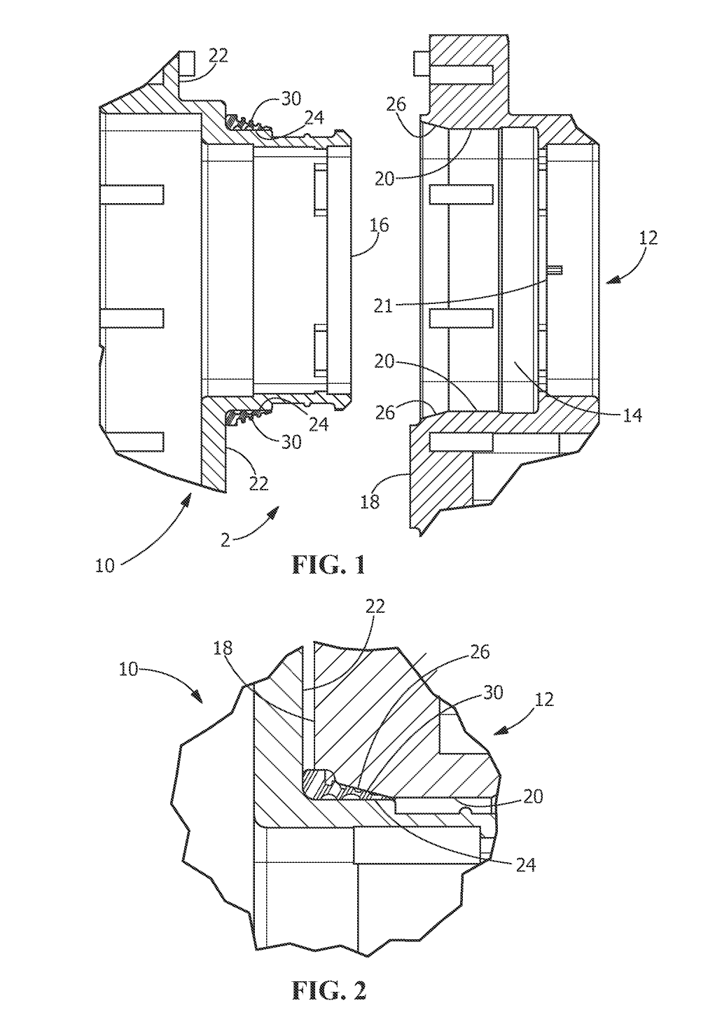

FIGS. 1 through 3 are sectional views of a connector assembly 2 having a first or plug connector housing 10 and a second or receptacle connector housing 12 with a peripheral wedge seal member 30 positioned on the plug connector housing. The first or plug connector housing 10 and the second or receptacle connector housing 12 may be mounted to a panel or substrate or may be free standing. The peripheral wedge seal member 30 may be secured to the plug connector housing 10 by known methods, such as, but not limited, to adhesive, mounting members or frictional engagement. The peripheral wedge seal member 30 may also be positioned on the receptacle connector and secured thereto by using known methods. Alternatively, the peripheral wedge seal member 30 may not be attached to either the plug connector housing 10 or the receptacle connector housing 12.

The plug connector housing 10 has terminals (not shown) which extend therethrough to mate with mating terminals (not shown) of the receptacle connector housing 12. As many different types of terminals and mating terminals may be used, a detailed description of such terminals and mating terminals shall not be provided.

As shown in FIG. 1, the receptacle connector housing 12 has a plug connector receiving opening 14 which is dimensioned to receive a mating portion 16 of the plug connector housing 10 therein. The mating connector receiving opening 14 has side walls 20 which extend from a plug connector engaging wall 18. An end wall 21 is provided at the bottom of the opening 14. The side walls 20 extend about the periphery of the opening 14. The side walls 20 may have linear configurations or may have arcuate surfaces or projections positioned thereon. Receptacle contacts (not shown) extend from the end wall 21 into the opening 16.

The mating portion 16 of the plug connector housing 10 has side walls 24 which extend from a receptacle connector engaging wall 22. The side walls 24 extend about the periphery of the mating portion 16 to form the mating portion 16. The side walls 24 may have linear configurations or may have arcuate surfaces or projections positioned thereon, such as, but not limited to, latching projections. The mating portion 16 has plug contacts (not shown) positioned in the mating portion 16 for electrically engaging the receptacle contacts when the plug connector housing 10 and the receptacle connector housing 12 are mated together. The mating portion 16 is dimensioned to be received in the opening 14 and movable therein between an unmated position and a mated position.

As the peripheral wedge seal member 30 may be used with plug connector housings 10 and receptacle connector housings 12 of many different configurations and sizes, a more detailed description of such plug connector housings 10 and receptacle connector housings 12 shall not be provided.

In the illustrative embodiment shown, the peripheral wedge seal member 30 is positioned on the side walls 24 of the mating portion 16 of the plug connector housing 10. The peripheral wedge seal member 30 is positioned proximate the receptacle connector engaging wall 22. As previously stated, the peripheral wedge seal member 30 may be secured to the mating portion 16 of the plug connector housing 10 by known methods, such as, but not limited, to adhesive, mounting members or frictional engagement.

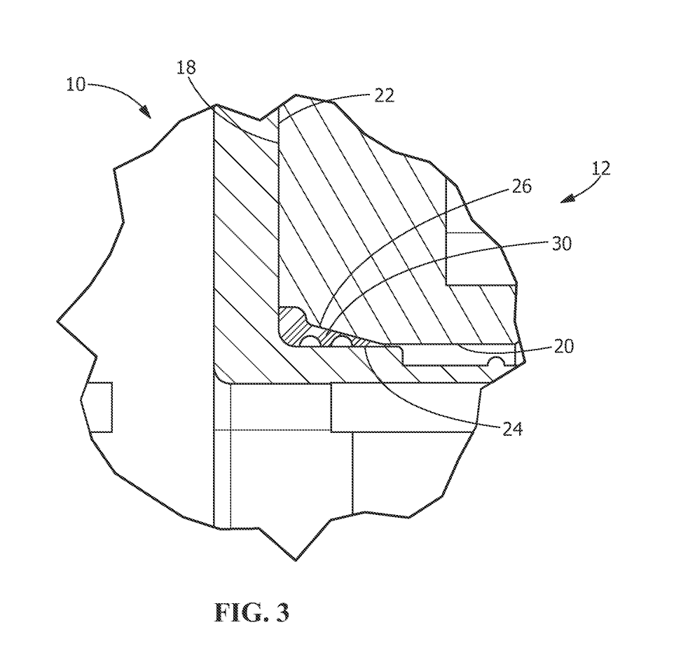

As shown in FIGS. 1 through 3, as the plug connector housing 10 and the receptacle connector housing 12 are moved together, the plug connector engaging wall 18 of the receptacle connector 12 is moved toward the receptacle connector engaging wall 22 of the plug connector housing 10. As the plug connector housing 10 and the receptacle connector housing 12 are moved from the position shown in FIG. 1 to the position shown in FIG. 2, leading portions 26 of the side walls 20 engage the peripheral wedge seal member 30. As the plug connector housing 10 and the receptacle connector housing 12 are moved from the position shown in FIG. 2 to the fully inserted position shown in FIG. 3, the peripheral wedge seal member 30 is compressed, thereby providing an effective seal between the side walls 20 of the receptacle connector housing 12 and the side walls 24 of the plug connector housing 10.

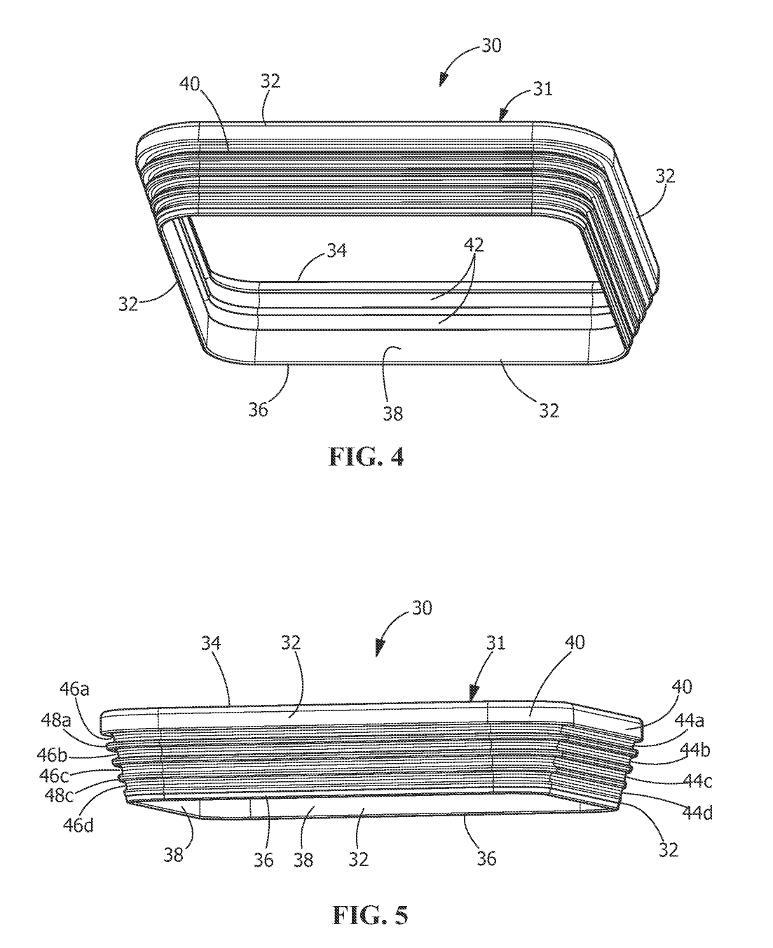

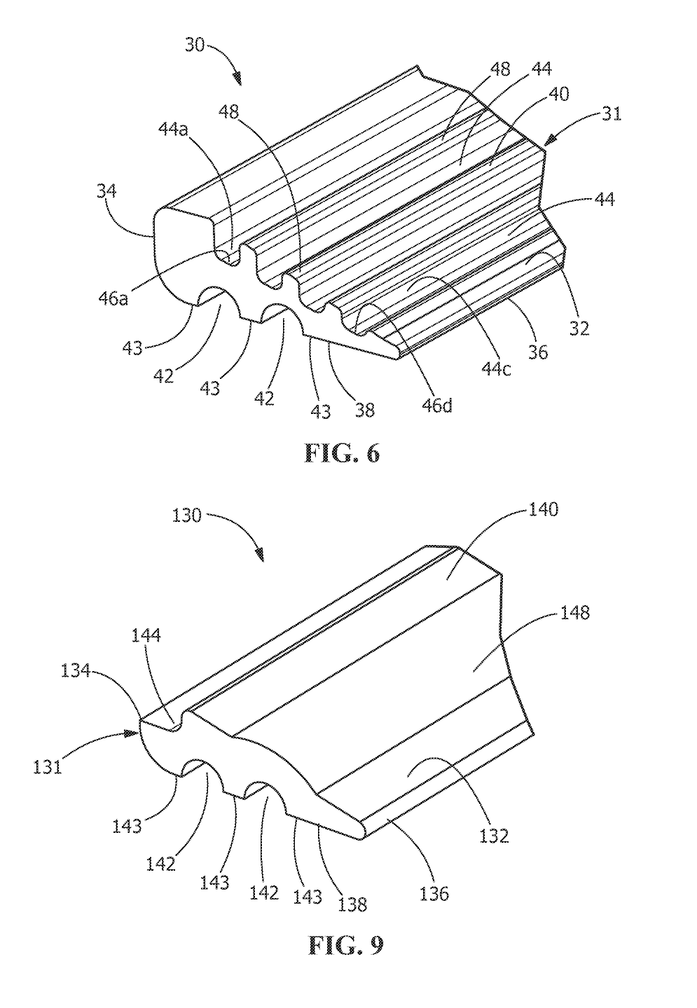

Referring to FIGS. 4 through 6, the peripheral wedge seal member 30 has a deformable body 31 which may be made from any material having the structural integrity and structural flexibility needed. Such material includes, but is not limited to, plastic, rubber or elastomeric. In the illustrate embodiment shown, the peripheral wedge seal member 30 is a rectangular member with tapered walls 32 which extend from a thicker first surface or end 34 to a less thick second surface or end 36, as best shown in FIG. 6. The walls 32 have first surfaces 38 and second surfaces 40 which extend at an angle relative to the first surfaces 38 to create the taper of the walls 32. While a rectangular member is shown, the peripheral wedge seal member 30 may have other configurations, including, but not limited to, square or round.

In the embodiment shown, the first surfaces 38 have two recesses or grooves 42 which extend the entire length of each respective wall 32. The grooves 42 and support ribs 43 provide there between and/or proximate thereto act as spring members to allow for better compression of the peripheral wedge seal member 30 when the plug connector housing 10 and the receptacle connector housing 12 are mated together. This allows the plug connector housing 10 and the receptacle connector housing 12 to be mated and unmated with reduced force. In addition, the grooves 42 and ribs 43 provide additional compliancy to the peripheral wedge seal member 30, allowing the peripheral wedge seal member 30 to provide vibration dampening between the plug connector housing 10 and the receptacle connector housing 12. The spacing provided between the grooves 42 and the size of the grooves 42 may vary depending upon the insertion forces, compliancy and vibration dampening characteristics desired for the particular connector assembly 2. While two grooves 42 are shown on each side wall 32, other number of grooves may be used without departing from the scope of the invention.

The second surfaces 40 have four recesses or channels 44 which extend the entire length of each respective wall 32. As the walls 32 of peripheral wedge seal member 30 are tapered, the channels 44 have slightly different configurations depending upon their location on the second surfaces 40. For example, channels 44a have bottom surfaces 46a which are positioned further from second surfaces 40 than bottom surfaces 46d of channels 44d. Deformable ribs 48 are provided between and/or proximate to the channels 44. As the walls 32 of the peripheral wedge seal member 30 are tapered, the ribs 48 have slightly different configurations depending upon their location on the second surfaces 40. For example, ribs 48a are longer than ribs 48c. The recesses 44 and the ribs 48 are provided to allow for better compression of the peripheral wedge seal member 30 when the plug connector housing 10 and the receptacle connector housing 12 are mated together. This allows the plug connector housing 10 and the receptacle connector housing 12 to be mated and unmated with reduced force. In addition, the recesses 44 and the ribs 48 provide additional compliancy to the peripheral wedge seal member 30, allowing the peripheral wedge seal member 30 to provide a proper seal between the plug connector housing 10 and the receptacle connector housing 12 and to provide vibration dampening between the plug connector housing 10 and the receptacle connector housing 12. The spacing provided between the recesses 44 and the size of the ribs 48 may vary depending upon the insertion forces, compliancy and vibration dampening characteristics desired for the particular connector assembly 2. While four recesses 44 and three ribs 48 are shown on each side wall 32, other number of recesses and ribs may be used without departing from the scope of the invention.

The grooves 42, ribs 43, channels 44 and ribs 48 form compliant sections which are able to absorb forces transmitted by the plug connector housing 10, the receptacle connector housing 12 or both.

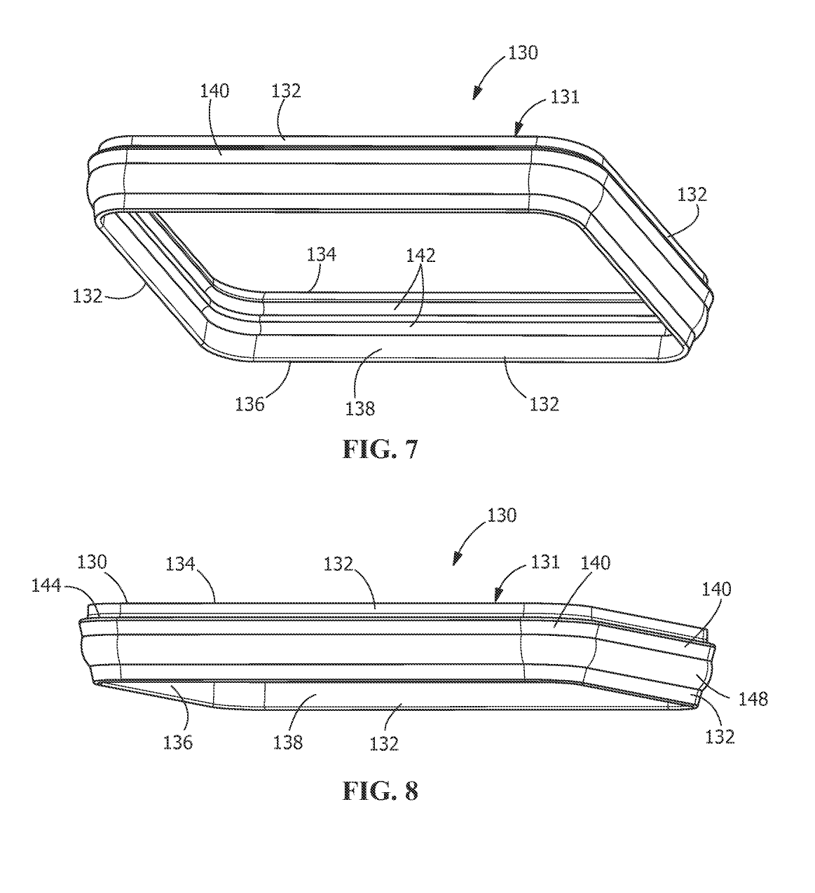

Referring to the alternate illustrative embodiment of FIGS. 7 through 9, the peripheral wedge seal member 130 has a deformable body 131 which may be made from any material having the structural integrity and structural flexibility needed. Such material includes, but is not limited to, plastic, rubber or elastomeric. In the illustrative embodiment shown, the peripheral wedge seal member 130 is a rectangular member tapered walls 132 which extend from a thicker first surface or end 134 to a less thick second surface or end 136, as best shown in FIG. 9. The walls 132 have first surfaces 138 and second surfaces 140 which extend at an angle relative to the first surfaces 138 to create the taper of the walls 132. While a rectangular member is shown, the peripheral wedge seal member 130 may have other configurations, including, but not limited to, square or round.

In the embodiment shown, the first surfaces 138 have two recesses or grooves 142 which extend the entire length of each respective wall 132. The grooves 142 and support ribs 143 provide there between and/or proximate thereto act as spring members to allow for better compression of the peripheral wedge seal member 130 when the plug connector housing 10 and the receptacle connector housing 12 are mated together. This allows the plug connector housing 10 and the receptacle connector housing 12 to be mated and unmated with reduced force. In addition, the grooves 142 and ribs 143 provide additional compliancy to the peripheral wedge seal member 130, allowing the peripheral wedge seal member 130 to provide vibration dampening between the plug connector housing 10 and the receptacle connector housing 12. The spacing provided between the grooves 142 and the size of the grooves 142 may vary depending upon the insertion forces, compliancy and vibration dampening characteristics desired for the particular connector assembly 2. While two grooves 142 are shown on each side wall 132, other number of grooves may be used without departing from the scope of the invention.

The second surfaces 140 have recesses 144 which extend the entire length of each respective wall 132. The recesses 144 are provided proximate the first end 134 of the walls 132. Deformable ribs 148 extend from the second surfaces 140. In the illustrative embodiment shown, the ribs 148 have curved or arcuate configurations which project from the second surfaces 140. The ribs are positioned between the recesses 144 and second ends 136. The recesses 144 and the ribs 148 are provided to allow for better compression of the peripheral wedge seal member 130 when the plug connector housing 10 and the receptacle connector housing 12 are mated together. This allows the plug connector housing 10 and the receptacle connector housing 12 to be mated and unmated with reduced force. In addition, the recesses 144 and the ribs 148 provide additional compliancy to the peripheral wedge seal member 130, allowing the peripheral wedge seal member 130 to provide a proper seal between the plug connector housing 10 and the receptacle connector housing 12 and to provide vibration dampening between the plug connector housing 10 and the receptacle connector housing 12. The spacing provided between the recesses 144 and the ribs, the size of the recesses 144 and the size of the ribs 148 may vary depending upon the insertion forces, compliancy and vibration dampening characteristics desired for the particular connector assembly 2. While one recess 144 and one rib 148 are shown on each side wall 132, other number of recesses and ribs may be used without departing from the scope of the invention.

The grooves 142, ribs 143, channels 144 and ribs 148 form compliant sections which are able to absorb forces transmitted by the plug connector housing 10, the receptacle connector housing 12 or both.

Peripheral wedge seals according to the present invention provide an effective seal over a wide range of functional housing dimensions, thereby accommodate a greater range of manufacturing tolerances than known seals. In addition peripheral wedge seals according to the present invention provide for lower mating and un-mating forces, provide more compliancy and provide sufficient vibration dampening between the plug connector the receptacle connector even in harsh environments.

In addition, as the seals are compressed when the plug connector housing and receptacle connector housing are mated, potential energy is developed and stored in the compliant sections. Consequently, when the plug connector housing and receptacle connector housing are unmated, the release of the compliant section releases the potential energy, thereby facilitating the unmating of the housings.

While the invention has been described with reference to an illustrative embodiment, it will be understood by those skilled in the art that various changes may be made and equivalents may be substituted for elements thereof without departing from the spirit and scope of the invention as defined in the accompanying claims. In particular, it will be clear to those skilled in the art that the present invention may be embodied in other specific forms, structures, arrangements, proportions, sizes, and with other elements, materials, and components, without departing from the spirit or essential characteristics thereof. One skilled in the art will appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments and methods are therefore to be considered in all respects as illustrative and not restrictive, the scope of the invention being defined by the appended claims, and not limited to the foregoing description or embodiments.

1. A seal member for use with a plug connector housing and a receptacle connector housing, the seal member comprising:
a deformable body having tapered walls which extend from a thicker first end to a less thick second end, each of the walls having a first surface and a second surface which is angled with respect to the first surface; and
at least one groove extending along the first surface, at least one support rib provided proximate the at least one groove, the at least one groove and the at least one support rib forming a spring member which allows the deformable body of seal member to compress when the plug connector housing and the receptacle connector housing are mated together.

2. The seal member as recited in claim 1, wherein the deformable body is plastic, rubber or elastomeric material.

3. The seal member as recited in claim 1, wherein the seal is a peripheral wedge seal with a rectangular configuration.

4. The seal member as recited in claim 1, wherein the seal is a peripheral wedge seal with a round configuration.

5. The seal member as recited in claim 1, wherein the at least one groove is two grooves with a support rib provided there between.

6. The seal member as recited in claim 1, wherein at least one recess extends along the second surface.

7. The seal member as recited in claim 6, wherein at least one deformable rib is provided proximate the at least one recess.

8. The seal member as recited in claim 6, wherein the at least one recess is four recesses which have different configurations depending upon their location on the second surface.

9. The seal member as recited in claim 6, wherein the at least one recess is provided proximate the first end.

10. The seal member as recited in claim 9, wherein at least one deformable rib is provided on the second surface between the at least one recess and the second end.

11. The seal member as recited in claim 10, wherein at least one deformable rib has a curved or arcuate configuration.

12. A peripheral wedge seal member for use with a plug connector housing and a receptacle connector housing, the peripheral wedge seal member comprising:
a deformable body having tapered walls which extend from a thicker first end to a less thick second end, each of the walls having a first surface and a second surface which is angled with respect to the first surfaces; and
each of the walls having a compliant section which absorbs forces transmitted by the plug connector housing, the receptacle connector housing or both, each compliant section having at least one groove extending along the first surface and at least one support rib provided proximate the at least one groove.

13. The peripheral wedge seal member as recited in claim 12, wherein the at least one groove is two grooves with a support rib provided there between.

14. The peripheral wedge seal member as recited in claim 12, wherein the compliant section includes at least one recess which extends along the second surface.

15. The peripheral wedge seal member as recited in claim 14, wherein the compliant section includes at least one deformable rib which is provided proximate the at least one recess.

16. The peripheral wedge seal member as recited in claim 15, wherein the at least one recess is four recesses which have different configurations depending upon their location on the second surface.

17. The peripheral wedge seal member as recited in claim 12, wherein the at least one recess is provided proximate the first end.

18. The peripheral wedge seal member as recited in claim 17, wherein the compliant section includes at least one deformable rib which is provided on the second surface between the at least one recess and the second end.

19. The peripheral wedge seal member as recited in claim 18, wherein at least one deformable rib has a curved or arcuate configuration.

20. A peripheral wedge seal member for use with a plug connector housing and a receptacle connector housing, the peripheral wedge seal member comprising:
a deformable body having tapered walls which extend from a thicker first end to a less thick second end, the walls having first surfaces and second surfaces which are angled with respect to the first surfaces; and
each of the walls having a compliant section which absorbs forces transmitted by the plug connector housing, the receptacle connector housing or both, each compliant section having at least one groove extending along the first surface, at least one support rib provided proximate the at least one groove, at least one recess which extends along the second surface, and at least one deformable rib which is provided proximate the at least one recess.
